(19) United States
(12) Patent Application Publication
(10) Pub. No.: US 2008/0063900 A1
(43) Pub. Date: Mar. 13, 2008

(54) Optical storage medium

(75) Inventor: Kuohua Wu, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/518,809

(22) Filed: Sep. 11, 2006

(51) Int. Cl. G11B 5/66; B32B 3/02

(52) U.S. Cl. 428/823.1; 428/64.1; 428/824; 369/13.4

(57) ABSTRACT

Various embodiments and methods relating to providing constructive interference of light between a reflective layer and an imageable layer are disclosed.

### CROSS-REFERENCE TO RELATED PATENT APPLICATIONS

The present application is related to co-pending U.S. patent application Ser. No. ______ filed on the same date herewith by Mehrgan E. Khavari and entitled STORAGE DISC, the full disclosure of which is hereby incorporated by reference.

### BACKGROUND

Optical storage media is used to store data. Some optical storage media is additionally configured to be labeled using a laser. Such labeling may lack satisfactory image quality.

### BRIEF DESCRIPTION OF THE DRAWINGS

FIG. 1 is a top perspective view of one example of an optical storage medium according to an example embodiment.

FIG. 2 is a sectional view of a portion of the storage medium of FIG. 1 taken along line 2-2 according to an example embodiment.

FIG. 3 is a sectional view of a portion of another embodiment of the storage medium of FIG. 1 according to an example embodiment.

FIG. 4 is a sectional view of a portion of another embodiment of the storage medium of FIG. 1 according to an example embodiment.

FIG. 5 is a graph illustrating reflectance of various embodiments of the storage medium of FIG. 4 according to an example embodiment.

FIG. 6 is a sectional view of a portion of another embodiment of the storage medium of FIG. 1 according to an example embodiment.

FIG. 7 is a sectional view of a portion of another embodiment of the storage medium of FIG. 1 according to an example embodiment.

### DETAILED DESCRIPTION OF THE EXAMPLE EMBODIMENTS

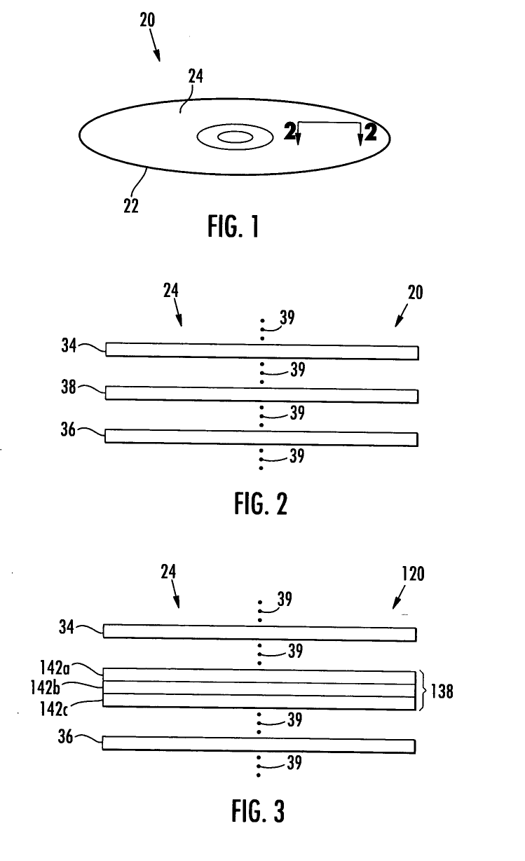

FIG. 1 illustrates one example of a storage medium 20 according to an example embodiment. Storage medium 20 comprises an optical storage medium configured to store data. In the example illustrated, storage medium 20 comprises an optical storage disc that is configured to be rotatably driven to facilitate retrieval of data from storage medium 20 using a laser. In one embodiment, such data is readable by sensing reflection of coherent light from a data side 22 of medium 20. The light reflected from data side 22 of medium 20 varies based upon the data stored on the medium 20. In other embodiments, medium 20 may have other configurations for storing and facilitating retrieval of data.

For purposes of this disclosure, the term “data” shall mean information that is encoded so as to be machine or computer-readable. For example, information may be digitally encoded with binary bits or values. Such data may have different formats such as various presently or future created music, photo and document formats. Such data is upon storage medium 20. Although the existence of the data on the disc may, in some embodiments, be visually seen by the human eye as darker or lighter rings on the disc, the content or information encoded by the data is generally not readable by a human eye. In other words, the darker or lighter rings that may be viewed on the disc do not communicate information to a person viewing the rings and do not identify or label characteristics of the data.

Storage medium 20 is further configured to have one or more labels written upon it. For purposes of this disclosure, the term “label” shall mean any image, graphic, photo, drawing, picture, alphanumeric symbols, design and the like that are visible to a human eye. Such labeling may directly communicate information regarding the content or characteristic of the data on storage medium 20 to a person. Such labeling may also alternatively visually communicate other unencoded information to a person. In particular embodiments, the labeling may also contain computer readable security data without altering the visual appearance of the labeling. In one embodiment, such labels are viewable from a label side 24 of medium 20. In other embodiments, both data and labeling may be read are viewed from a common side of medium 20.

FIG. 2 illustrates storage medium 20 in more detail. FIG. 2 is a sectional view of selected layers of the storage medium 20 of FIG. 1 taken along line 2-2. As shown by FIG. 2, storage medium 20 includes writable or imageable layer 34, reflective layer 36 and interference enhancement layer 38. As indicated by the ellipses 39, medium 20 may include one or more multiple other layers on one or more sides of layers 34, 36 and 38. In other embodiments, one or more layers 34, 36 and 38 may be directly adjacent to one another.

Imageable layer 34 comprises one or more layers of one or more materials configured to facilitate the writing of a label upon medium 20 with electromagnetic energy or light. In the particular example illustrated, layer 34 facilitates writing of a label using a laser. In one embodiment, layer 34 comprises one or more thermochromic materials configured change optical properties (such as optical density) when subjected to energy such as infrared radiation, ultraviolet radiation or visible light.

For example, in one embodiment, such thermochromic materials may include a leuco dye which may change color with the application of heat or in the presence of an activator (developer). In one embodiment, the dye may include fluoran-based compounds. In some embodiments, writable layer 34 may additionally include a radiation-absorbing material to facilitate absorption of one or more wavelengths of marking radiation. One Example of such a radiation-absorbing material is an infrared dye. In one embodiment, imageable layer 34 may be configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, imageable layer 234 may alternatively include other materials.

Reflective layer 36 comprises one or more layers of one or more materials having sufficient reflectivities (high indexes of refraction) so as to substantially reflect visible light that has passed through writable layer 34 back towards a person viewing label side 24 of medium 20. In one embodiment, layer 36 comprises a layer of one of more metals which are highly reflective such as silver or aluminum. In other embodiments, other reflective metals or nonmetals may be used. In the yet other embodiments, storage medium 20 may alternatively be provided with a sufficient number of interference enhancement layers 38 so as to sufficiently reflect light, facilitating omission of layer 36

Interference enhancement layer 38 comprises a layer of optically transparent material disposed between layers 34 and 36 and configured to enhance reflection of light from layer 36 by providing constructive optical interference to light being transmitted between layers 34 and 36. In one embodiment, layer 38 is configured such that one or more wavelengths of light are substantially in phase with one another. For purposes of this application, “constructive optical interference” means the refraction of electromagnetic waves such that the phases of two or more electromagnetic waves are closer to being in the phase with one another such that the combined amplitude of the waves is greater than the amplitude of a single wave. Two electromagnetic waves that are in phase with one another have a combined amplitude substantially equal to the sum of the amplitude of the individual waves.

In the particular embodiment illustrated, layer 38 is configured provide constructive optical interference for a selected range of wavelengths less than a total spectrum of visible light. For example, in one embodiment, layer 38 may be configured or “tuned” to provide constructive interference for red wavelengths of light such that light reflected from the side of 24 of medium 20 has a reddish hue. In other embodiments, layer 38 may be configured to provide constructive interference for other wavelengths of light such as blue or green wavelengths of light which cause light reflected from side 24 of medium 20 have a blue or greenish hue or color, respectively. Because layer 38 provides constructive interference of light being transmitted between layers 34 and 36, the brightness and quality of the image provided by layers 34 and 36 is enhanced. In one embodiment, layer 38 is configured to provide constructive interference for one or more colors of visible light distinct from the one or more colors of visible light reflected by those portions of imageable layer 34 that have been irradiated with electromagnetic energy, such as with a laser. In such embodiments, contrast or sharpness of the label image may be enhanced.

In addition to or as an alternative to enhancing image brightness or sharpness being observed by a person, interference enhancement layer 38 may also facilitate the writing or imaging of a label upon imageable layer 34. For example, in one embodiment, interference enhancement layer 38 provides constructive interference to those wavelengths of light used to image or write the label upon layer 34. As a result, a greater percentage of light energy from the laser or other imaging device that initially passes through layer 34 and is not absorbed by layer 34 is reflected back towards layer 34. This additional light energy irradiating layer 34 may enable layer 34 to be imaged or written upon in less time or with a less powerful laser, reducing costs or improve the image quality.

The particular wavelengths of visible light for which layer 38 provides constructive interference are based upon the optical indices which includes refractive index, the extinction coefficient and the thickness of the material of layer 38 relative to such properties of layers 34 and 36. With appropriate selection of such properties for layer 38, the brightness of light transmitted and reflected from side 24 of medium 20 is enhanced. According to one embodiment, layer 38 may be formed from materials including, but not limited to, SiO2, TaOx, ZrOx, ZnOS, NbOx, HfOx, TiOx, ITO (indium tin oxide), CaF2, and BaF2. In particular embodiments, layer 38 as a thickness of between about 5 nm and about 500 nm. In other embodiments, layer 38 may be formed from other materials and may have other thicknesses.

FIG. 3 illustrates a portion of optical storage medium 120, another embodiment of medium 120. Optical storage medium 20 is similar to medium 20 except that medium 120 include a multilayer interference enhancement arrangement 138 in lieu of layer 38. Those remaining components of medium 120 which correspond to components of medium 20 are numbered similarly.

Multilayer interference enhancement arrangement 138 includes interference enhancement layers 142a, 142b and 142c (collectively referred to as interference enhancement layers 142). Interference enhancement layers 142 are each similar to interference enhancement layer 38 (shown and described with respect to FIG. 2) in that each of layers 142 comprises an optically transparent layer of material configured to enhance reflection of light from layer 236 by providing constructive optical interference to light being transmitted between layers 34 and 36. Layers 142 cooperate with one another such that reflection of a larger or broader range of the visible spectrum of light is enhanced. In one embodiment, layers 142 alternate between layers of material having a high index of refraction and layers of material having a low index of refraction. For purposes of this application, and material having a “high index of refraction” is a material having a refraction index greater than two and a material having a low index of refraction is a material having a refractive index of less than two. For example, in one embodiment, layers 142a and 142c may be formed from a material having a high refractive index such as ZiO, TiO, TaO while layer 142b is formed from a material having a low refractive index such as AlO, SiO, CaF, BaF. In yet another embodiment, layers 142a and 142c may alternatively be formed from a material having a low refractive index while layer 142b is for from a material having a high refractive index. According to one embodiment, layers 142a and 142c may be formed from a common material and may have the same thickness. In other embodiments, layers 142a and 142c may be formed from the same material while having different thicknesses. With an appropriate number of interference layers 142 of appropriate materials having selected refractive indices and thicknesses, the range of wavelengths within the visible spectrum of light to which arrangement 138 applies constructive interference may be enlarged as desired. As a result, brightness of the label image reflected from side 24 of medium 20 is enhanced.

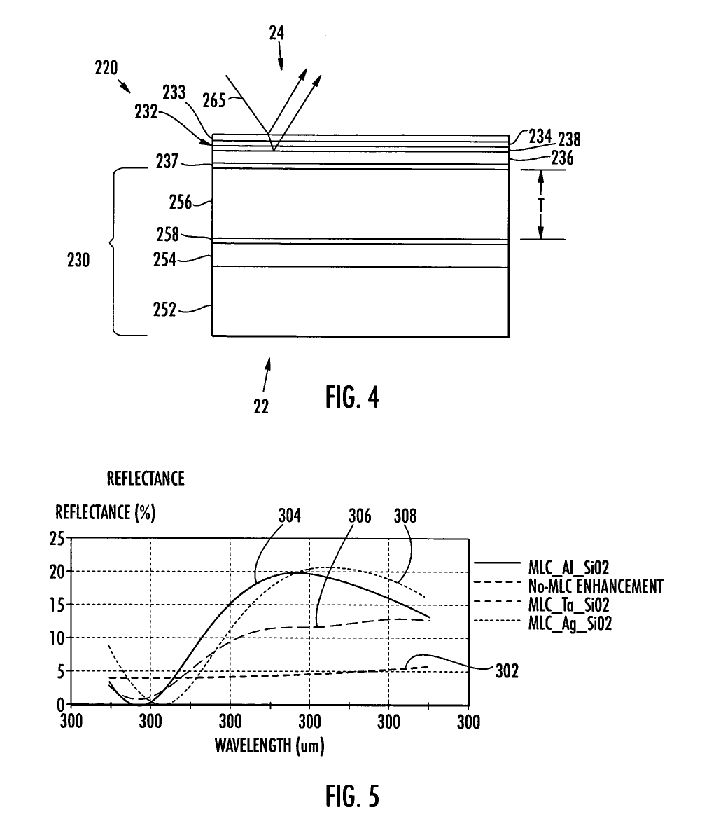

FIG. 4 is a sectional view of a portion of optical storage medium 220, another embodiment of optical storage medium 20. Optical storage medium 220 includes data portion 230 and label portion 232. Data portion 230 is configured to facilitate the writing of data to medium 220 using a source of coherent light such as a laser. Data portion 230 includes substrate layer 252, data layer 254, substrate layer 256 and reflective layer 258.

Substrate layer 252 comprises a layer of transparent material configured to permit the transmission of coherent light there through to layers 254 and 258 and the reflection of light from layer 258 back through layer 252 for being read by a sensing device facing data side 22 of medium 220. According to one embodiment, layer 252 additionally serves as a base or supporting layer for layer 254 during fabrication of medium 220. According to one embodiment, layer 252 comprises polycarbonate. In other embodiments, layer 252 may be formed from other transparent materials.

Layer 254 comprises one or more layers of one or more materials configured to be written upon by electromagnetic energy, such as a laser. In particular, layer 254 is configured to be written upon with a laser so as to encode binary or other machine-readable data in layer 254. In one embodiment, such data is written in layer 254 along spiral grooves extending about a rotational axis of medium 220. In one embodiment, layer 254 comprises a layer or film of material which changes in optical characteristic upon being irradiated with a laser. According to one embodiment, layer 254 is formed from one or more phase-change materials. In other embodiments, layer 254 the alternatively be formed from other materials such as a thermochromic material or other material configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, imageable layer 234 may alternatively include other materials. In other embodiments, other materials that change between different optical states upon being irradiated with a laser may be employed.

Substrate layer 256 comprises one or more layers of one or more materials spacing data layer 254 from label portion 232. In one embodiment, layer 256 further serves as a base or foundation layer upon which reflective layer 258 is formed during fabrication of medium 220. In one embodiment in which data portion 230 comprises a DVD, layer 256 has a thickness of about 600 μm. In another embodiment in which data portion 230 comprises a Blu-ray disc, layer 256 has a thickness T of about 1100 μm. In one embodiment in which data portion 230 is configured to permit light to be reflected off reflective layer 258 from label side 24, such as when data portion 230 is configured to be used with the writable layer, such as layer 234 shown described with respect to FIG. 2 without a reflective layer, such as reflective layer 236, layer 256 is formed from a transparent material. According to one embodiment, layer 256 is formed from polycarbonate. In other embodiments, layer 256 may be formed from other transparent, translucent or opaque materials.

Reflective layer 258 comprises one or more layers of one or more reflective materials having sufficient reflectivities so as to reflect light that has passed through data layer 254 back towards an optical sensing device located opposite side 22 of medium 220. In one embodiment, layer 258 comprises a layer of one of more metals which are highly reflective such as silver or aluminum. In other embodiments, other reflective metals or nonmetals may be used.

According to one method of fabrication, layer 258 comprises a single film deposited upon substrate layer 256. Layer 254 comprises single layer of writeable material deposited upon substrate layer 252. Layers 256 and 258 and layers 252 and 254 are then stacked and joined to one another with layers 254 and 258 sandwiched between layers 252 in 256. In other embodiments, data portion 230 may be formed another ways.

Label portion 232 comprises one or more layers coupled to data portion 230 to facilitate writing of a label on medium 220 using a source of energy, such as a source of coherent light like a laser. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

Label portion 232 includes protective layer 233, writable or imageable layer 234, reflective layer 236, coupling layer 237 and interference enhancement layer 238. Protective layer 233 comprises one or more layers of one or more transparent materials configured to protect imageable layer 234 from scratches or other damage. Layer 233 may additionally protect imageable layer 234 and reflective layer 236 from environmental conditions such as moisture or humidity. Examples of such a material include UV-curable lacquers like Daicure SD2200 or SD2407 by Dainippon Ink or Desolite 650-020, 650-030, 650-031, or 650-033 from DSM Desotech. In other embodiments, layer 233 may include other materials, may be located adjacent reflective layer 236 or may be omitted.

Layer 234 comprises one or more layers of one or more materials configured to facilitate the writing or imaging of a label upon medium 220 with electromagnetic energy or light. In the particular example illustrated, layer 234 facilitates writing of a label using a laser. In one embodiment, layer 234 comprises one or more thermochromic materials configured change optical properties (such as optical density) when subjected to energy such as infrared radiation, ultraviolet radiation or visible light.

For example, in one embodiment, such thermochromic materials may include a leuco dye which may change color with the application of heat or in the presence of an activator (developer). In one embodiment, the dye may include fluoran-based compounds. In some embodiments, imageable layer 234 may additionally include a radiation-absorbing material to facilitate absorption of one or more wavelengths of marking radiation. Examples of such a radiation-absorbing material include an infrared dye. In one embodiment, imageable layer 234 may be configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, imageable layer 234 may alternatively include other materials.

Reflective layer 236 comprises one or more layers of one or more materials having sufficient reflectivities so as to reflect visible light that has passed through imageable layer 234 back towards a person viewing label side 24 of medium 20. In one embodiment, layer 236 comprises a layer of one of more metals which are highly reflective such as silver or aluminum. In other embodiments, other reflective metals or nonmetals may be used.

Coupling layer 237 comprises one or more layers of one or more materials coupled to layer 236 and configured to adhere reflective layer 236 two substrate layer 256. In one embodiment, coupling layer 237 may comprise one or more layers of one or more dielectric materials or semi-metal materials. Examples of such materials include, but are not limited to, SiO2, TaOx, ZrOx, ZnOS, NbOx, HfOx, TiOx, ITO, CaF2, and BaF2

In particular embodiments, coupling layer 237 may additionally be configured to apply a compressive force to reflective layer 236 and a remainder of medium 220 upon substantially complete cure or solidification. In such an embodiment, coupling layer 237 applies a compressive force that counters the tensile force resulting from the addition of layer 236. As a result, in those embodiments in which medium 220 comprises an optical disc, label portion 232 may be added to a storage disc including data portion 230, but lacking the ability to be written upon with a light source, without substantial adjustment or altering of the fabrication of data portion 230 while maintaining medium 520 within prescribed radial tilt specifications. In one embodiment, layer 237 has a compressive stress sufficient to lower overall tension of medium 220 such that medium 220 has a radial tilt of less than or equal to about 0.7 degrees. In such an embodiment, layer 237 has a thickness of between about 50 angstroms and about 600 angstroms. One embodiment to layer 237 may be formed from one or more of Ta, Ti, Zirconium, Al₂O₃, SiO₂, and TiO₂. In other embodiments, layer 237 may be formed from other materials.

Interference enhancement layer 238 is similar to interference enhancement layer 38 described above with respect to FIG. 4. Interference enhancement layer 238 comprises a layer of optically transparent material disposed between layers 234 and 236 at configured to enhance reflection of light from layer 236 by providing constructive optical interference to light being transmitted between layers 234 and 236. In the particular embodiment illustrated, layer 238 is configured provide constructive optical interference for a selected range of wavelengths less than a total spectrum of visible light.

The particular wavelengths of visible light for which layer 238 provides constructive interference are based upon the refractive index, the extinction coefficient and the thickness of the material of layer 238 relative to such properties of layers 234 and 236. With appropriate selection of such properties for layer 238, the brightness of light transmitted and reflected from side 24 of medium 220 is enhanced. According to one embodiment, layer 238 may be formed from materials including, but not limited to, SiO2, TaOx, ZrOx, ZnOS, NbOx, HfOx, TiOx, ITO, CaF2, and BaF2. In particular embodiments, layer 38 has a thickness of between about 5 nm and about 500 nm. In other embodiments, layer 238 may be for from other materials and may have other thicknesses.

Because layer 238 provides constructive interference of light (such as light 265) being transmitted between layers 234 and 236, the brightness and quality of the image provided by layers 234 and 236 is enhanced. In one embodiment, layer 238 is configured to provide constructive interference for one or more colors of visible light distinct from the one or more colors of visible light reflected by those portions of imageable layer 234 that have been irradiated with electromagnetic energy, such as with a laser. In such embodiments, contrast of the label image may be enhanced.

FIG. 5 is a graph comparing enhanced reflectivities provided by various embodiments of medium 220 with the reflectivities of a medium 220 lacking layers 236, 237 and 238. In particular, line 302 depicts the reflectivity of a medium 220 lacking layers 236, 237 and 238. Each of the mediums of FIG. 5 include layers 252 and 256 which each comprise polycarbonate and have thicknesses of about 1.2 mm and 0.6 mm, respectively. Each of the mediums include layer 254 which comprises a phase change material having a thickness of about 400 nm. In each of the mediums, layer 258 comprises Al or Ag having a thickness of about 100 nm, layer 234 comprises BK-400 or Black 400 commercially available from Nagase America and having a thickness of about 4000 nm and layer 233 comprises Daicure SD2200 or SD2407 by Dainippon Ink or Desolite 650-020, 650-030, 650-031, or 650-033 from DSM Desotech having a thickness of about 200 nm.

The mediums represented by lines 304, 306 and 308 additionally include layers 236, 237 and 238. Layer 237, extending on an opposite side of layer 236 as layer 238 and does not impact reflectivity of such mediums. In contrast, layers 236 and 238 cooperate to enhance reflectivity as shown by FIG. 5. Line 304 depicts a reflectivity of medium 220, wherein layer 236 comprises aluminum and has a thickness of approximately 200 nm and wherein layer 238 comprises a first layer of TiO2 having a refractive index of 2.48 and a thickness of about 100 nm and a second layer of SiO2 having a refractive index of 1.47 and a thickness of about 87 nm. Line 306 depicts reflectivities of medium 220, wherein layer 236 comprises Ta and has a thickness of approximately 250 nm and wherein layer 238 comprises a first layer of TiO2 having a refractive index of 2.48 and a thickness of about 48 nm and a second layer of SiO2 having a refractive index of 1.47 and a thickness of about 92 nm. Line 308 depicts a reflectivities of medium 220, wherein layer 236 comprises Ag and has a thickness of approximately 100 nm and wherein layer 238 comprises a first layer of TiO2 having a refractive index of 2.48 and a thickness of about 68 nm and a second layer of SiO2 having a refractive index of 1.47 and a thickness of about 52 nm. As illustrated by such examples, the addition of layers 236 and 238 increase reflectance for a sharper, higher contrast label. In addition, labeling of medium 220 has reduced blurriness, radial tilt caused by different coefficient of thermal expansion of such layers is reduced and adhesion of imageable layer 234 to the remainder of medium 220 is enhanced.

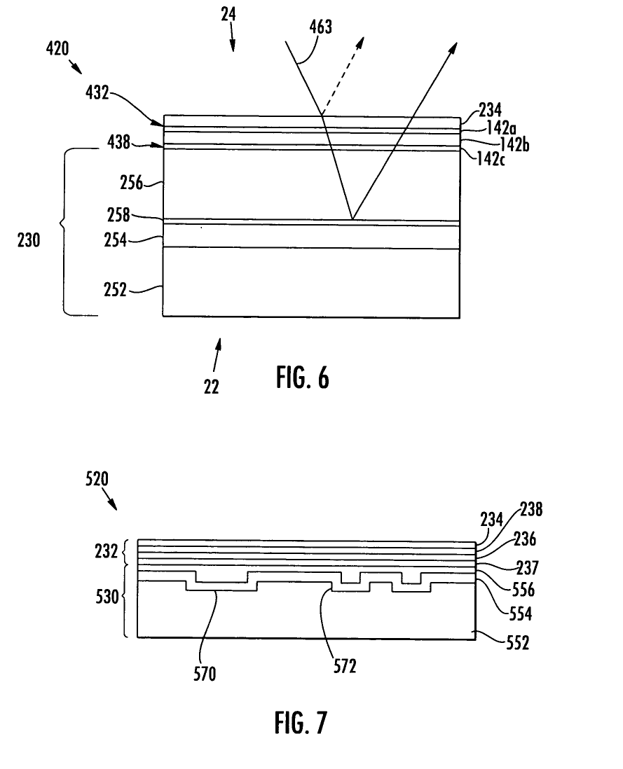

FIG. 6 is a sectional view of a portion of optical storage medium 420, another embodiment of medium 20. Medium 420 is similar to medium 220 except that medium 420 includes label portion 432 in lieu of label portion 232. Those remaining components of medium 420 which correspond to components of medium 220 are numbered similarly.

Label portion 432 is similar to label portion 232 except that label portion 432 omits reflective layer 236 and coupling layer 237. Label portion 432 further includes multilayer interference enhancement arrangements 438 in lieu of interference enhancement layer 238. Arrangement 438 is similar to arrangement 138 described above with respect to FIG. 3. Arrangement 438 includes multiple optical interference enhancement layers 142a, 142b and 142c, also described above with respect to FIG. 3. In other embodiments, arrangement 438 may include a fewer or greater number of such optical interference enhancement layers. In some embodiments, medium 420 may include a single interference layer 238 in lieu of the multilayer arrangement 438 shown.

FIG. 6 further illustrates reflection of light 463 from label side 24 of medium 420. In particular, light 463 passes through those portions of imageable layer 234 which remain at least partially transparent or translucent. In one embodiment, light 463 passes through those portions of layer 234 that have not been substantially irradiated with electromagnetic energy such as coherent light from a laser. Light 463 passes through arrangement 438 and through substrate layer 256 until being reflected by reflective layer 258. Thereafter, light 463 is reflected back through substrate layer 256, through multilayer arrangement 438 and through imageable layer 234 for being observed. Multilayer arrangement 438 provides constructive interference to enhance the amplitude or brightness of the visible light exiting side 24 of medium 420.

FIG. 7 is a sectional view of a portion of optical storage medium 520, another embodiment of medium 20. Medium 520 is similar to medium to 220 except that medium 520 includes data portion 530 in lieu of data portion 230. The remaining components of medium 520 which correspond to components of medium 220 are numbered similarly. Data portion 530 includes substrate layer 552, data layer 554 and substrate layer 556. Layers 552, 554 and 556 cooperate to provide a fixed set of data that may be read from medium 520. Substrate layer 552 comprises a layer of transparent material configured to permit light, such as laser light, to pass therethrough and to be reflected by layer 554. In one embodiment, such a layer 552 has a grooved or pitted surface 570 which defines the grooved or pits of data layer 554. In one embodiment, such grooves or pits are stamped or otherwise formed in layer 552. In yet other embodiments, surface 570 may be planar, wherein data layer 554 has varying thickness. In one embodiment, layer 552 comprises polycarbonate. In other embodiments, layer 552 may comprise one or more other materials.

Data layer 554 comprises one or more layers of reflective material coupled to layer 552. In one embodiment, data layer 554 comprises a layer of film of material such as aluminum or silver. In other embodiments, layer 554 may be formed from other reflective materials.

As shown by FIG. 7, data layer 554 includes pits 572 which form elevated and depressed portions which reflect light differently, wherein the different reflection of light by layer 554 corresponds to data stored in data layer 554.

Layer 556 comprises a layer of material spacing a remainder of data portion 530 from label portion 232. In one embodiment, layer 556 comprises a layer of acrylic formed upon reflective layer 556. In other embodiments, layer 556 may comprise one or more other materials.

As shown by FIG. 7, label portion 232 may be added to an existing data portion 530 which includes preconfigured are set data stamped or otherwise currently formed. Label portion 232 facilitates customize labeling of such data storage mediums. Interference enhancement layer 238 (or in alternative embodiments, arrangement 438) provides customized labeling of medium 520 with enhanced image quality.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An optical storage medium comprising:
an imageable layer; and
a first transparent layer configured to provide constructive interference of visible light passed through the imaginable layer and reflected.

2. The apparatus of claim 1, wherein the first transparent layer provides constructive interference for a first range of wavelengths less than a total spectrum of visible light.

3. The apparatus of claim 2 further comprising a second transparent layer, wherein the first transparent layer and the second transparent layer provide constructive interference for a second larger range of wavelengths less than the total spectrum of visible light.

4. The apparatus of claim 3, wherein the first transparent layer has an index of refraction greater than two and wherein the second transparent layer has an index of refraction less than two.

5. The apparatus of claim 4 further comprising a third transparent layer, wherein the third transparent layer is on opposite side of the second transparent layer as the first transparent layer and wherein the third layer has an index of refraction greater than two.

6. The apparatus of claim 5, wherein the first transparent layer and the second transparent layer are formed from one or more same dielectric materials.

7. The medium of claim 6 wherein the first transparent layer and the second transparent layer have distinct thicknesses.

8. The medium of claim 1, wherein the imageable material reflects a first color of light after being irradiated with electromagnetic energy and wherein the first transparent layer is configured to provide constructive interference of a second color of light different than the first color of light.

9. The medium of claim 1, wherein the first transparent layer is selected from a group of transparent materials consisting of: a dielectric material, a semi-metal material and combinations thereof.

10. The medium of claim in 1, wherein the first transparent layer is selected from a group of materials consisting of: SiO2, TaOx, ZrOx, ZnOS, NbOx, HfOx, TiOx, ITO, CaF2, and BaF2.

11. The medium of claim 1 further comprising a data portion, the data portion comprising:
a data layer; and
a reflective layer.

12. The medium of claim 11, wherein the data layer is configured to be written upon with electromagnetic energy.

13. The medium of claim 11, wherein the data layer includes pits representing data.

14. The medium of claim 12 further comprising polycarbonate between the reflective layer and the imageable layer.

15. The medium of claim 1, further comprising a reflective layer, wherein the first transparent layer extends between the imageable layer and the reflective layer.

16. The medium of claim 15, wherein the first transparent layer is adjacent to the first reflective layer.

17. An optical storage medium comprising:
a data layer;
a first reflective layer on a first side of the data layer;
a second reflective layer on a second side of the data layer;
an imageable layer on opposite side of the second reflective layer as the first reflective layer; and
a first transparent layer between the second reflective layer and the imageable layer, the first transparent layer being configured to provide constructive interference of visible light transmitted between the second reflective layer and the imageable layer.

18. A method comprising:
reflecting light from a first reflective layer towards an imageable layer of an optical storage medium; and
enhancing phase alignment of light been transmitted between the first reflective layer and the imageable layer.

19. The method of claim 18 further comprising reading data from the optical storage medium by sensing light reflected from a second reflective layer of the optical storage medium.

20. The method of claim 18 further comprising directing coherent light through the imageable layer to the reflective layer.
